(19) United States
(12) Patent Application Publication
(10) Pub. No.: US 2020/0226011 A1
(43) Pub. Date: Jul. 16, 2020

(54) POLICY-BASED DISTRIBUTED TRANSACTIONAL PROCESSING IN A DISTRIBUTED SYSTEM

(71) Applicants: Changqing Ye, Irvine, CA (US); Ping Liang, Newport Coast, CA (US)

(72) Inventors: Changqing Ye, Irvine, CA (US); Ping Liang, Newport Coast, CA (US)

(73) Assignee: Fast River Technologies Inc., Irvine, CA (US)

(21) Appl. No.: 16/246,954

(22) Filed: Jan. 14, 2019

(51) Int. Cl. G06F 9/54; G06F 11/07

(52) U.S. Cl. CPC G06F 9/546; G06F 11/0745; G06F 2209/547; G06F 11/0793; G06F 11/0751

(57) ABSTRACT

This invention discloses embodiments of a method and a system of distributed processing of transactions by a plural of participating applications, each acting asynchronously and independently from other participating applications. The method comprises using one or more configurable policy records, accepting from a participating application update of the state of the processing of a transaction and/or update of a configurable policy record of a transaction independent of the other participating applications, using a message manager to receive and stores one or more messages over time from one or more producers and distributes the messages to one or more subscribing consumers of the messages, and recording the states of processing of a transaction by the participating applications in a transaction state record. Each participating application starts or joins a transaction based on a policy, updates its state of processing in the transaction state record, and checks the policy record to determine its next action.

### FIELD OF INVENTION

This invention relates generally to transaction processing and management, and more particularly to methods and systems of global transaction management of multiple independent applications executing transactions in a distributed system.

### BACKGROUND OF INVENTION

Emerging technologies and application requirements, e.g., stream processing and integrated systems, lambda architecture platforms, microservices, big data platform, increase the variety and complexity of application transaction semantics. Each application in a distributed system concurrently, independently or dependently produces, consumes and processes events or messages. Furthermore, these applications require access to multiple streaming data sources as well as traditional stored data sources. Execution ordering of distributed applications is random, and there is no clear transaction boundary. Each application that participates in a global transaction can start or end a transaction, each takes unpredictable time to complete business logic on the events or messages received. In these systems, preserving global transaction ACID (Atomicity, Consistency, Isolation, Durability) properties and integrity of processing is often problematic and challenging. Prior art container-managed transaction mechanism through a global transaction manager does not work in these situations because a participating application may not even run in any container. The present invention discloses novel methods and systems of managing global transactions using definitive policies that solves the above difficulties in an efficient, flexible and extensible manner with the benefit of global system performance.

### SUMMARY OF INVENTION

This invention discloses embodiments of a method and a system of distributed processing of transactions comprising using one or more configurable policy records to store the definition of a transaction and specify which two or more participating applications are included in the processing of the transaction and one or more rules that specify conditions each participating application need to follow when processing the transaction to ensure the integrity of the transaction, wherein a participating application is implemented by a computer program and is either a producer which produces messages over time or a consumer which receives messages over time from one or more producers to whom it subscribes; accepting from a participating application update of the state of the processing of a transaction and/or update of a configurable policy record of a transaction independent of the other participating applications; using a message manager to receive and stores one or more messages over time from one or more producers and distributes the messages to one or more subscribing consumers of the messages; and recording the states of processing of a transaction by the participating applications in a transaction state record, wherein each participating application, acting asynchronously and independently from other participating applications, starts or joins a transaction based on a policy, updates its state of processing in the transaction state record, and checks the policy record to determine its next action.

Furthermore, in the method or system, a rule of a transaction in the policy record may specify a global transaction is ready to commit if all participating applications are prepared to commit by a transaction boundary time defined in the policy record and require each participating application to commit its action upon knowing from the transaction state record that a global transaction is ready to commit; and wherein when each participating application is prepared to commit its action, it updates its state in the transaction state record to indicate that it is prepared to commit, and upon knowing from the transaction state record that all specified participating applications participating in the transaction have updated their transaction state record to indicate that they are prepared to commit, each participating application commits its action and updates its state in the transaction state record by the transaction boundary time.

The policy record may include a rule that specifies that a global transaction fails if one or more participating application fails to process or fail to complete by a transaction boundary time defined in the policy record and requires each participating application to rollback its action when a global transaction fails; and wherein each participating application completes its processing but rolls back its action by reversing to its previous state upon knowing from the transaction state record that one or more participating applications in the transaction fail to process or fail to complete by the transaction boundary time.

The policy record may also include a rule of a transaction in the policy record specifies that upon knowing from the transaction state record that one or more other participating applications in the transaction have failed, a participating application stops processing the transaction and rolls back its action.

The method or system may further comprises using a transaction state notifier to notify each participating application in a transaction when the transaction state record is updated, or each participating application performing a failure recovery process based on a policy in the policy record of the transaction, or accepting an input from a user interface or an API, and generating or editing the transaction policy record of a transaction, including the definition of a transaction, the rules and the transaction boundary time, or one or more participating applications accessing the policy record of a transaction and edit some or all parts of the policy record through a policy manager, including definition of a transaction, the rules and the transaction boundary time.

### BRIEF DESCRIPTION OF DRAWINGS

The present invention is disclosed in the following detailed description and the accompanying drawings.

FIG. 1 illustrates an example of a distributed transactional stream system comprising of one or more producer applications and consumer applications, and a message manager.

FIG. 2 is a functional block diagram illustrating a policy-based global transaction management for a distributed transactional stream system in FIG. 1.

FIG. 3 delineates metadata of transaction record and policy record of a policy-based global distributed transactional processing.

FIG. 4 is state transition diagram for a global transaction and for a participating application.

FIG. 5 is an example of a policy comprising a set of participating applications and a policy with 5 rules.

FIG. 6 illustrates an example of transaction record table consisting of 6 distinct transaction records.

FIG. 7 illustrates an example of a sequence diagram illustrating interactions between participating applications, transaction agent and policy manager in a policy-based distributed transactional processing.

FIG. 8 illustrates a block diagram illustrating start processing of policy-based distributed transactional processing of a participating application and transaction agent.

FIG. 9 illustrates a block diagram illustrating prepare-to-commit processing of policy-based distributed transactional processing of a participating application and transaction agent.

FIG. 10 is a block diagram illustrating commit processing of policy-based distributed transactional processing of a participating application and transaction agent.

FIG. 11 is a block diagram illustrating rollback processing of a participating application and transaction agent.

FIG. 12 is a block diagram illustrating failure recovery processing of a participating application.

This invention discloses novel methods and systems for managing global transactions in a distributed system through definitive policies. Policy-based distributed transactional processing consists of policy records, transaction records, transaction agent and policy manager; wherein a policy is a set of rules that specify conditions each participating application in the transaction to follow to ensure the integrity of the transaction; e.g., one rule that defines a transaction boundary time that determines how long a transaction expires if the transaction cannot complete in the defined boundary time; one or more rules that specify how many applications and which application participate a transaction under the policy, also has one or more rules that are used to determine how any application that participates a transaction can prepare to commit, commit, or abort the transaction; a rule can be completely user-defined, or predefined and customizable; a rule can be defined in any industrial standard format, e.g., XML, JSON, and DSL (domain-specific language); A policy can be stored as a policy record in any industrial standard database or proprietary-built storage; a policy is thread-safe, any of participating applications under the policy can read the same policy, only one application of them can perform atomic update on the policy.

A policy manager is used to manage policy records, e.g., creates, updates, and reads a policy record from the storage; each application that participates a transaction or a user interface executes the policy manager to add or update rules of any policy, enlist or delist the application to or from the policy with definitive privileges.

An application that intends to participate a transaction executes to enlist the application to a specific policy through a policy manager; A participating application under a policy that wants to disassociate a transaction executes to delist the application from the policy through a policy manager; Each of the applications that participate a global transaction plays equivalent role or nonequivalent role in transaction processing and conducts the transaction based on the policy. Each of the applications that participate a transaction may be an initiator of a transaction or the terminator of the transaction. Each global transaction must associate one policy. Initiating a global transaction creates a new transaction record wherein a transaction record consists of a policy Id which uniquely identify a policy record associating with this transaction, a list of applications that participate this transaction determined by the policy and a list of states of the corresponding applications, a transaction state, a message Id or a group Id that uniquely identify one or more messages or events that are processed in this transaction scope, transaction start timestamp, and transaction end timestamp. A participating application updates its application state and the transaction state based on the policy. A transaction record is thread-safe, any of participating applications under the policy can read the same transaction record, only one application of them can perform atomic update on the transaction record; transaction records can be stored in any industrial standard database or proprietary-built storage.

A transaction agent is used to create, update, and read a transaction record based on a policy; the transaction agent accesses the policy record that associates with the transaction through a policy manager; each application that participates a transaction uses the transaction agent to create a transaction record if it is the initiator of the transaction, update its application state and the state of the transaction based on the policy associated with the transaction. Each application ether shares one transaction agent instance or has its own transaction agent instance depends on the embodiment.

All participating applications require access to multitude resources including stream data sources as well as stored data sources. An application that participating a transaction has different legal states: INACTIVE, ACTIVE, PREPARED, FAILED, COMMITTED and ROLLEDBACK wherein a state transits to a different state based on the policy and the different action; an application starts with INACTIVE state where the application does not yet receive any message(s) or event(s) and does not yet start any business logic processing; an application in ACTIVE state is in process; an application is in PREPARED state after the application prepares a commit for its local resources or its local transaction; an application in PREPARED state either rolls back or commits; If any error or exception occurs, the application goes to the FAILED state. An application in FAILED state must roll back. An application in COMMITTED or ROLLED-BACK state is final state that indicates the one logical transactional process cycle finishes and can start the next cycle. The state of an application caches in memory and retains in the transaction record of the storage, the value in memory and that in the transaction record of the storage are synchronized.

A transaction has distinct legal states: ACTIVE, ACTIVE/PREPARED (PARTIALLY PREPARED), ACTIVE/FAILED, COMMITTED and ROLLEDBACK wherein a transaction agent is used to compute each state of a transaction based on the policy and the states of applications that participate the transaction. By the default rules of a policy of the embodiment, a global transaction is active only if each of participating applications is either active or inactive; a global transaction is committed only if all participating applications are committed; a global transaction is rolled-back only if all participating applications are rolled-back; a global transaction is active only if each of participating applications is either prepared or active or inactive; a global transaction is active/failed only if each of participating applications is either failed or rolled-back or active or inactive wherein one of participating applications must be failed or rolled-back.

The policy-based transaction management mechanism ensures that all distributed participating applications and resources either commit or roll back together. A transaction can fail during any aspect of processing, e.g., a server or database crashes, a network connection fails, or an unhandled software exception occurs. A transaction that fails becomes in-doubt and leaves the system open to potential inconsistence. An in-doubt transaction recovers the system and participating applications back to consistent state after the distributed systems or participating applications restart. A failure recovery is also distributed and executed by each participating application through the transaction agent.

The policy-based distributed transactional processing does not have a centralized global transaction manager that manages transactions and states; The complexity of distributed transaction management reduces, and the efficiency and productivity of data flow processing enhances, e.g., a participating application is aware of the failure of other participating applications and discontinue processing and trigger the roll back of a transaction.

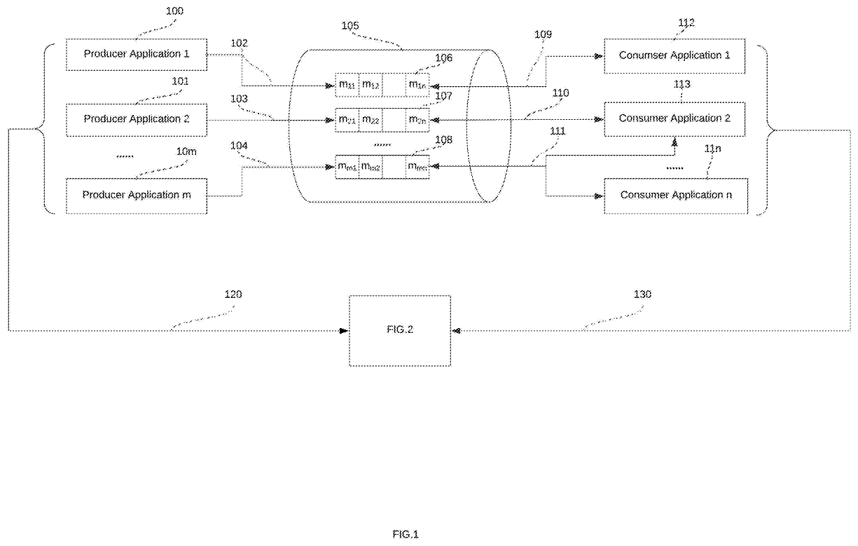

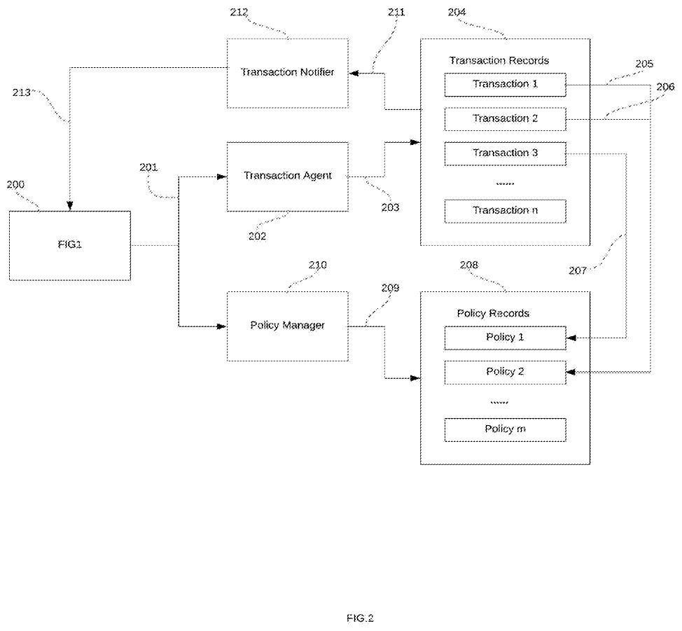

FIG. 1 is the first part of a block diagram illustrating a policy-based distributed transactional stream system of this invention comprising of a message manager 105, one or more producer applications 100, 101 and 10m, one or more consumer applications 112, 113, and 11n, and the components shown in FIG. 2. A message manager 105 has one or more message streams 106, 107 and 108; wherein each message stream stores a sequence of messages or events over time in first-in and first-out (FIFO) order. A producer application sends messages to its stream to which the producer application is registered. The message manager delivers one or more messages from each stream to one or more consumer applications that subscribe to the stream. All producer and consumer applications run in distributed and concurrency mode. The underlying message manager guarantees delivery of a message from a stream to a consumer application that subscribes to it exactly once. If there is any failure during a message delivery or if the consumer application fails to process the received message(s) and rolls back the said message(s), the message manager redelivers the rolled-back message(s) until it was consumed and committed. Based on the embodiment, a message manager may drop a message if the redelivery fails with configurable times. 120 and 130 indicate that a producer or consumer application can participate in a transaction by enlisting to a policy that associates with the transaction using a policy manager shown in FIG. 2.

FIG. 2 is the second part of the block diagram of FIG. 1 illustrating a policy-based distributed transactional system comprising of a transaction agent 202, a policy manager 210, transaction notifier 212, a set of transaction records 204, and a set of policy records 208. A transaction agent manages transaction records through an industry standard interface 203, e.g., JDBC, RESTFul API. A transaction record is thread-safe. A policy manager manages policy records through an industry standard interface 209, e.g., JDBC, RESTFul API. A policy record is also thread-safe. Each transaction record associates with one and only one policy record, e.g., line 205 indicates that transaction 1 associates with policy 2; line 206 indicates that the transaction 2 also associates with policy 2; line 207 indicates that the transaction 3 associates with policy 1. Multiple transactions can associate with the same policy record, e.g., line 205 and line 206 indicate both transaction 1 and transaction 2 associate with policy 2. A participating application executes the transaction agent and the policy manager. A transaction notifier 212 notifies a participating application which registers with the transaction notifier 212 for any change on the transaction record by sending asynchronous notifications to the application that registers through an industry standard interface 213, e.g., RESTFul API.

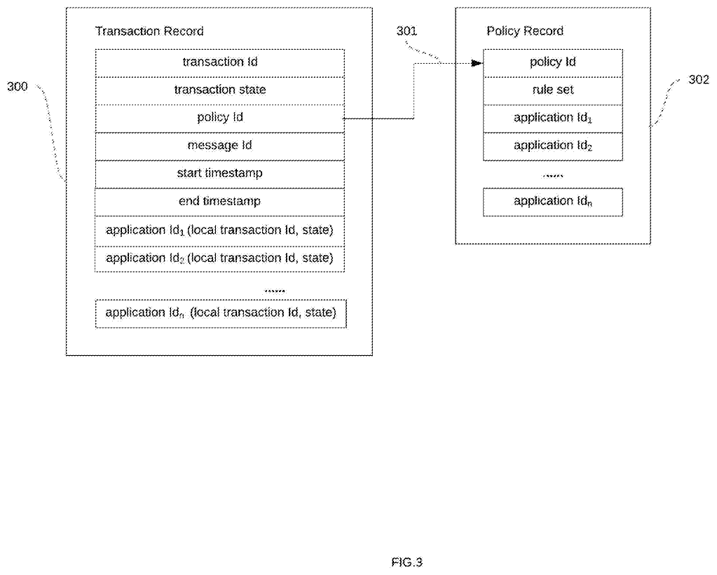

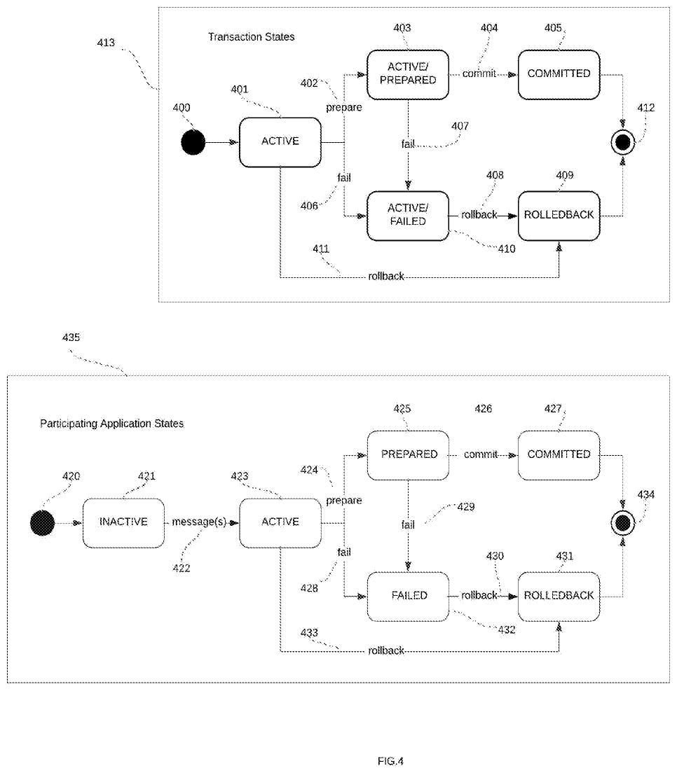

FIG. 3 illustrates an example of the metadata of a transaction record and a policy record. A transaction record 300 includes a transaction Id, a transaction state, a policy Id, a message Id or a group message Id, start timestamp, end timestamp, one or more pairs of local transaction Id and state of a participating application. A transaction Id is a globally unique identifier of a transaction. A transaction state specifies a status of a transactional process, and legal states of a transaction are described in FIG. 4. A policy Id is a reference 301 to the policy record in 302. A message Id or a group message Id is a unique identifier of one or more messages that any participating application receives and this transaction processes in one processing cycle. The same messages from a stream are broadcasted to multiple consumer applications that subscribe to the stream concurrently. A start timestamp is the time when the transaction starts, and an end timestamp is the time when the transaction ends. Each participating application in a transaction retains a pair of state and local transaction Id. The local transaction Id is the transaction identifier in the scope of the participating application. The local transaction Id is automatically generated. Usually, a local transactional resource manager of the participating application generates the local transaction Id. A policy record 302 consists of a policy Id, a rule set, one or more application Ids that are managed by the policy, e.g., application Id₁, application Id₂, application Idₙ in 302. A rule set defines multiple rules each of which determines the criteria for preparing a transaction, committing a transaction, failing a transaction and rolling back a transaction. A rule can be completely user-defined or predefined and customizable. The rule format may follow any industry standard, e.g., JSON, XML or DSL (domain-specific language).

FIG. 4 is a state transition diagram of a transaction and a participating application. A transaction starts with ACTIVE state and can be in any legal state of ACTIVE, ACTIVE/PREPARED, ACTIVE/FAILED, COMMITTED and ROLLEDBACK. A participating application starts with INACTIVE state and can be in any legal state of INACTIVE, ACTIVE, PREPARED, FAILED, COMMITTED and ROLLEDBACK. A transaction in either COMMITTED or ROLLEDBACK state ends.

A transaction is ACTIVE only if each participating application is in either INACTIVE or ACTIVE;

A transaction is ACTIVE/PREPARED if all participating applications are in either INACTIVE or ACTIVE or PREPARED wherein at least one of them is in PREPARED;

A transaction is ACTIVE/FAILED if all participating applications are in either INACTIVE or ACTIVE or PREPARED or ROLLEDBACK or FAILED wherein at least one of them is in either FAILED or ROLLEDBACK;

A transaction is COMMITTED only if all participating applications are in COMMITTED;

A transaction is ROLLEDBACK only if all participating applications are in ROLLEDBACK;

A transaction or a participating application transits from one state to another state based on the policy and the action determined by the policy, wherein a transaction moves ACTIVE state 401 to ACTIVE/PREPARED state 403 if any one of participating application prepares a commit based on the policy; A transaction moves to ACTIVE/FAILED 410 state either from ACTIVE state 401 or from ACTIVE/PREPARED state 403 if any failure happens or the participating application is required to roll back based on the policy; A transaction moves from ACTIVE/PREPARED state 403 to COMMITTED state 405 if all participating applications prepare to commit and commit; A transaction moves from ACTIVE/FAILED state 410 to ROLLEDBACK state 409 if all participating applications roll back. A transaction can directly move ACTIVE state 401 to ROLLEDBACK state 409 if all participating applications roll back.

Wherein a participating application moves from INACTIVE state 421 to ACTIVE state 423 after it receives message(s) or starts to process; A participating application moves from ACTIVE state 423 to PREPARED state 425 if the application meets a condition for preparing to commit and prepares to commit based on the policy; A participating application moves from PREPARED state 425 to COMMITTED state 427 if the participating application meets a condition to commit and commits based on the policy; A participating application moves to FAILED state 432 either from PREPARED state 425 or from ACTIVE state 423 if any failure occurs or the participating application is required to roll back based on the policy; A participating application moves from FAILED state 432 to ROLLEDBACK state 431 once the participating application rolls back; A participating application moves directly from ACTIVE state 423 to ROLLEDBACK state 431 if the participating application is required to rollback based on the policy.

In the most situations after a participating application prepares a commit, a participating application waits for a condition to meet for a commit through the transaction agent based on the policy; A new transaction associated with a policy starts only after the current transaction commits or rolls back. Depends on the embodiment of a distributed system, in some situations, a participating application can initiate a new transaction once the application successfully prepares a commit or performs a local commit based on the policy. Ordering of global transaction commit is defined by a policy and maintained by the policy.

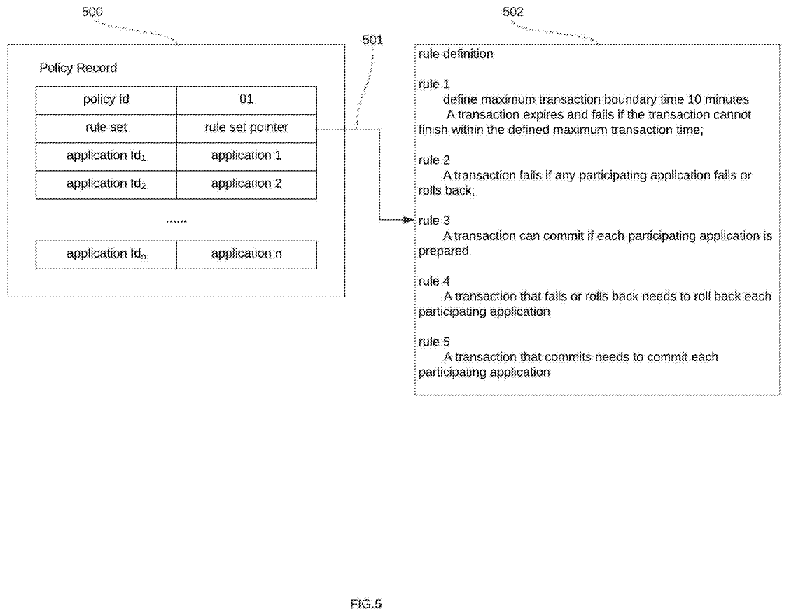

FIG. 5 illustrates an example of a policy record 500 comprising of n applications, e.g., application 1, application 2, . . . , and application n, a policy Id 01, and a rule set pointer 501 pointing a policy that consists of five rules 502. Rule 1 defines the maximum transaction boundary time as 10 minutes. A global transaction expires and fails if the transaction cannot finish within the defined maximum transaction boundary time. Rule 2 fails a global transaction if any participating application fails or rolls back. Rule 3 commits a global transaction if all participating application are prepared. Rule 4 rolls back all participating applications when a global transaction fails. Rule 5 commits a global transaction when all participating applications have committed.

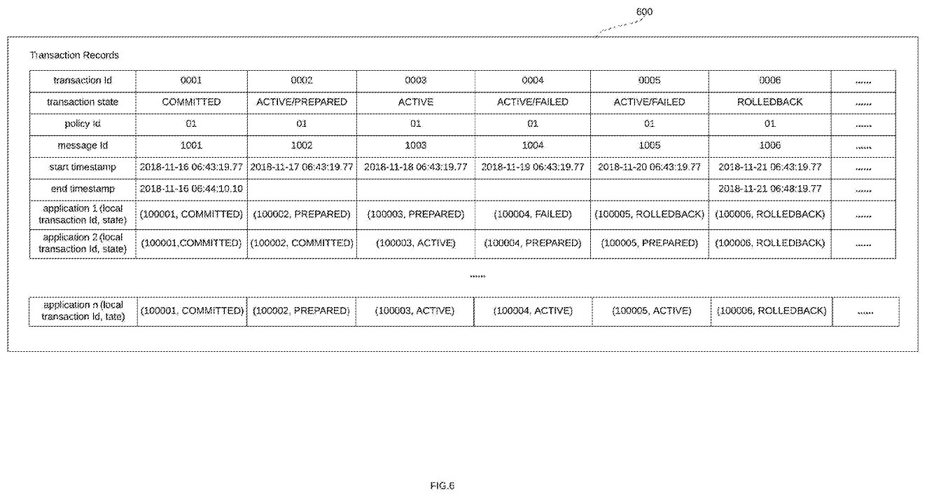

FIG. 6 illustrates examples of transaction records. Table 600 contains six different transaction records wherein transaction record 0001 in the second column of 600 delineates that the policy Id associated with this transaction 0001 is 01. The message Id in the transaction is 1001. All participating applications, e.g., application 1, application 2, to application n, have committed (in COMMITTED state). Thus, the transaction state row of the second column indicates that the transaction has ended and is in COMMITTED state. Both the start timestamp and end timestamp are recorded. A new transaction can start.

The transaction record 0002 in the third column of 600 indicates that the policy Id associated with this transaction 0002 is 01. The message Id in the transaction is 1002, and each participating application, e.g., application 1, application 2 to application n, is either prepared or committed (in either PREPARED or COMMITTED state). The transaction state row of the third column of 600 indicates that the transaction is prepared (in ACTIVE/PREPARED state), the transaction is still active and some of the participating applications are committed, some of the participating applications are in PREPARED state. The applications that do not yet commit are in progress of commit. The transaction is not finished yet, the end timestamp is not recorded. In an asynchronous embodiment, the transaction notifier notifies a participating application that does not yet commit to perform a local commit. Once all participating applications successfully commit and the transaction agent updates the transaction state to COMMITTED in memory and/or storage and finishes the transaction.

The transaction record 0003 in the fourth column of 600 indicates that the policy Id associated with this transaction 0003 is 01. The message Id in the transaction is 1003. Each participating application is prepared or activated (in either ACTIVE or PRPEARED state). In row 7 of the fourth column, local transaction 100003 of application 1 is prepared (in PREPARED state), and in row 8 of the fourth column, local transaction 100003 of application 2 is in ACTIVE state. The second row of the fourth column, transaction state, indicates that the transaction is still active. Some of participating applications are still in progress and do not prepared to commit yet. The applications in PREPARED state wait for a condition to meet for a commit based on the policy.

The transaction record 0004 in the fifth column of 600 indicates that the policy Id associated with this transaction 0004 is 01. The message Id in the transaction is 1004. One or more participating applications failed. Row 7 of the fifth column of 600 denotes that the local transaction 100004 of application 1 fails (in FAILED state), and row 8 of the fifth column of 600 denotes that local transaction 100004 of application 2 is prepared (in PREPARED state). The last row of the fifth column of 600 denotes that local transaction 100004 of application n is active. Consequently, the global transaction is failed (in ACTIVE/FAILED state). All the participating applications require to roll back to the original state in memory and/or storage based on the policy.

The transaction record 0005 in the sixth column indicates that the policy Id associated with this transaction 0005 is 01. The message Id in the transaction is 1005. One or more participating applications rolled back. Row 7 of the sixth column of 600 denotes that local transaction 100005 of application 1 rolled back (in ROLLEDBACK state) and row 8 of the sixth column of 600 denotes that local transaction 100005 of application 2 is prepared (in PREPARED state). The last row of the sixth column of 600 denotes that local transaction 100005 of the application n is active (in ACTIVE state). Hence, the global transaction is in ACTIVE/FAILED state. All participating applications that does not yet roll back require to roll back to the original state, then the transaction agent updates the transaction state to ROLLEDBACK state in memory and/or storage based on the policy.

The transaction record 0006 in the seventh column of 600 indicates that the policy Id associated with this transaction 0006 is 01. The message Id in the transaction is 1006. All participating applications rolled back (in ROLLEDBACK state). Row 2 of the seventh column indicates that the transaction is rolled back (in ROLLEDBACK state). The transaction ends. A new transaction can start.

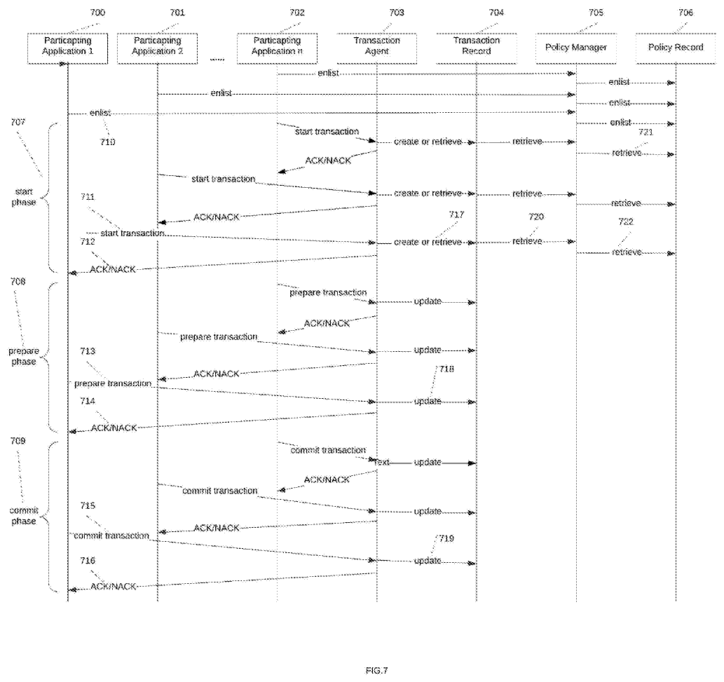

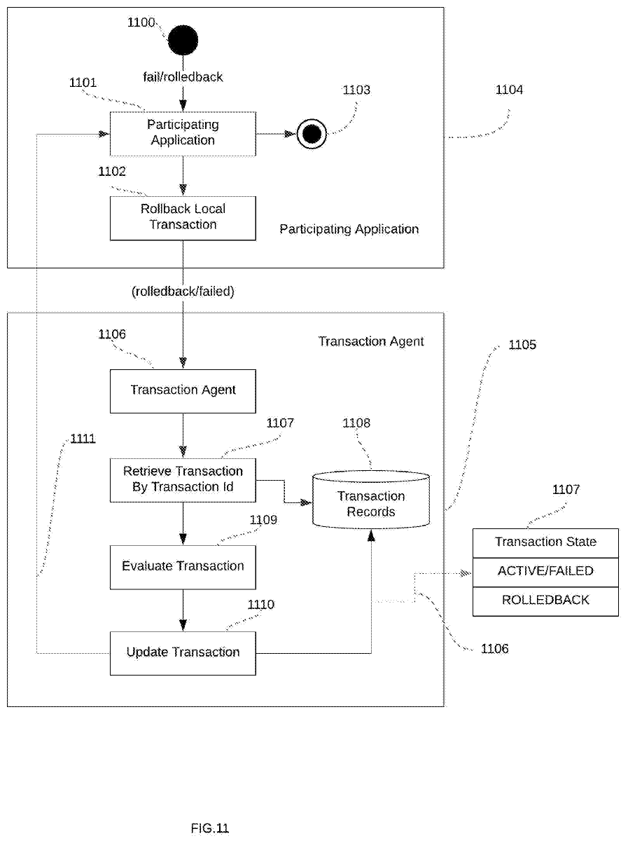

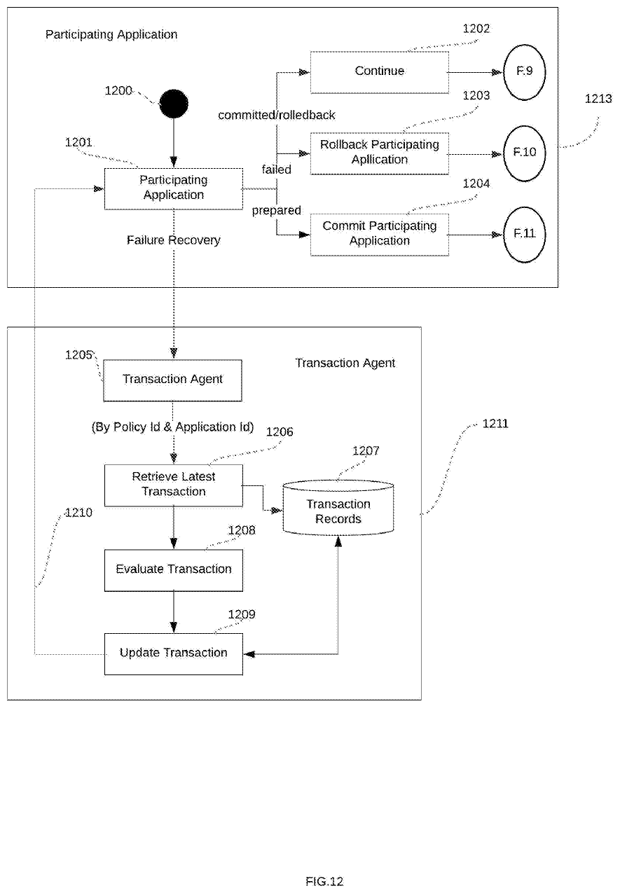

FIG. 7 is an example of a sequence diagram illustrating that multiple participating applications, e.g., participating application 700, participating application 701, and participating application 702, interact with different components in the policy-based distributed transactional system including transaction agent 703, transaction record 704, policy manager 705, and policy record 706. Any application, e.g., participating application 1 700, must enlist 710 to a policy in order to participate in a transaction using a policy manager 705. A global transaction can be broken down into multiple phases, e.g., start phase 707, prepare phase 708 and commit phase 709. Any participating application or the distributed system may fail during processing. The recovery process of a failure is described in FIG. 11, FIG. 12 and FIG. 13.

In start phase 707, each participating application, e.g., 700, executes a transaction agent 703 to start a transaction 711 using its enlisted policy Id and the message Id that the application received. The transaction agent 703 creates a new transaction or joins 717 an existing active transaction based on the policy. If the transaction agent determines to create a transaction, it creates a new transaction record; if the transaction agent determines to join an existing active transaction, it retrieves the existing transaction record. The transaction record is uniquely identified by the policy Id and message Id from the transaction record table 704. The transaction agent 704 accesses 720 to the policy record 706 using a policy manager 705 in order to create a new transaction record. The transaction agent updates the state of the application by using the application Id to ACTIVE and returns ACK back to the application. Once the application receives ACK 712 from the transaction agent, the application starts to process the message(s) and perform the business logic. If a NACK 712 returns to the application, the application fails to start or join a transaction.

In prepare phase 708, when a participating application, e.g., 700, is ready to prepare to commit its action based on the policy, the participating application prepares a local commit first, then prepares a global transaction 713 to update 718 the transaction record 704 through the transaction agent 703. The transaction agent computes the state of the transaction based on the policy that associates with the transaction. If the resulted state of the transaction is ACTIVE/FAILED, the transaction agent returns NACK 714 back to the application. Otherwise, the transaction agent returns ACK 714 back to the application. The application rolls back for NACK; the application continues to commit for ACK.

In commit phase 708, when a global transaction is ready to commit based on the policy, each participating application, e.g., 700, performs a local commit, then commits the global transaction 715 through the transaction agent 703, the transaction agent updates the transaction record 719. The transaction agent 703 returns either ACK or NACK 716 back to the application. If the application receives ACK, it continues to process; otherwise a recovery process requires. Once a global transaction in PREPARED state and/or one or more participating applications complete commit, if any component in the system including a transaction manager or a policy manage fails, or any participating application fails to commit, a rollback or recovery process requires.

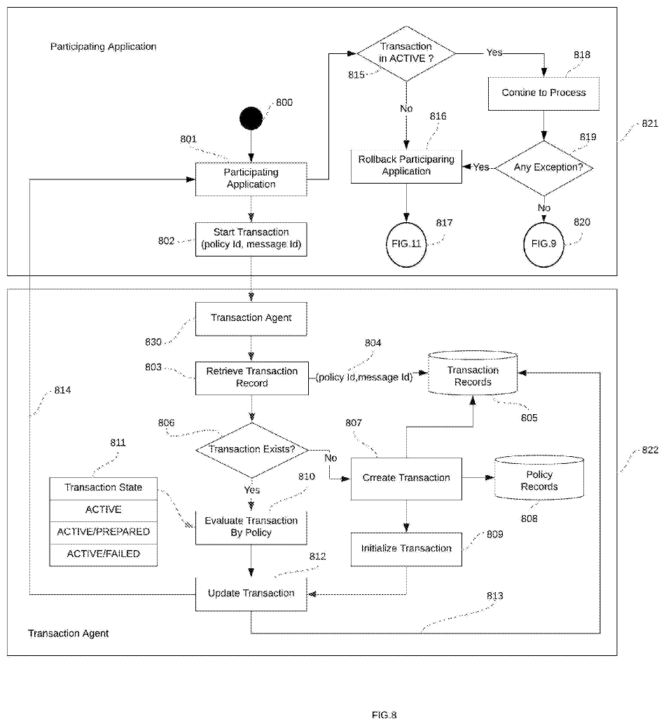

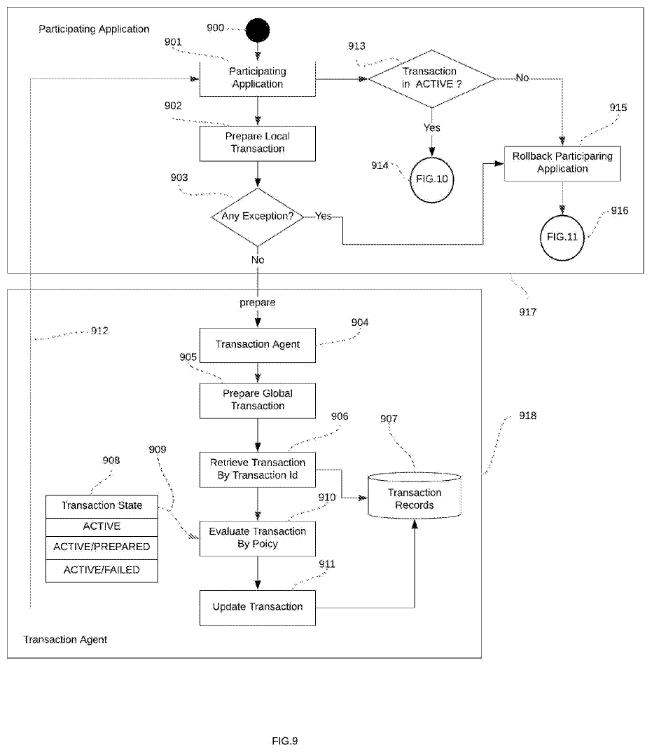

FIG. 8 depicts the start processing of a participating application in a policy-based distributed transactional system. Block 821 is the processing flow of a participating application, and Block 822 is the processing flow of a transaction agent. A participating application 801 starts a transaction 802 using the policy Id that associates with the policy and the message Id that the application receives. The application executes the transaction agent 830. Block 803 retrieves the transaction record using the policy Id and the message Id 804 from the transaction records database 805 using an industry standard interface, e.g., JDBC that the database system supports. Block 806 determines whether the transaction record database contains any active transaction record that associates with the policy Id and message Id; f no such an active transaction record is found, the process moves to Block 807; otherwise moves to Block 810; Block 807 refers to the policy record using the policy Id in the policy record database 808 and creates a new transaction record; Block 809 initializes the transaction record and moves to Block 812; Block 810 evaluates the state of the transaction record based on the policy, the possible valid legal states of evaluation are listed in 811. Block 812 updates the transaction record in memory, persists it to the transaction records database/storage, and returns the processing back to the participating application 801, the participating application 801 goes to Block 815. Block 815 tests whether the state of the transaction is health; If the state of the transaction is either ACTIVE/FAILED, Block 815 moves to Block 816; otherwise the state of the transaction is ACTIVE, Block 815 goes to Block 818 to continue to process the rest of business logic; Block 819 tests whether any exception or error occurs during processing, if no exception or error occurs, the process moves to FIG. 9 for further process; otherwise the process moves to Block 816; Block 816 rolls back the transaction (Refer to FIG. 11).

FIG. 9 depicts the request-commit/prepare-to-commit processing of a policy-based distributed transactional system. Block 917 is the processing flow of a participating application, and Block 918 is the processing flow of a transaction agent. When a participating application 901 meets a condition for preparing a commit based on the policy, the participating application 901 requests a commit. Block 902 prepares a commit for the local resources and updates the state of the application. Block 903 tests whether an exception or error occurs during preparing a local commit; If any exception or error happens, the decision block 903 goes to Block 915; otherwise the decision block goes to Block 904 transaction agent. The participating application executes the transaction agent 904 to prepare global transaction 905. The transaction agent 906 retrieves the transaction record using the transaction Id from the transaction records database 907. Block 910 evaluates the state of the transaction based on the policy. The possible valid legal states of the transaction are listed in 908. Block 911 updates the transaction record in memory, persists it to the transaction database 907, then moves the processing back to the participating application 901. Block 901 moves the processing to Block 913. Block 913 tests whether the state of the transaction is health; if the state of the transaction is ACTIVE, Block 913 changes to Block 914 for further processing; otherwise the processing moves to Block 915. Block 915 rolls back the transaction (Refer to FIG. 11).

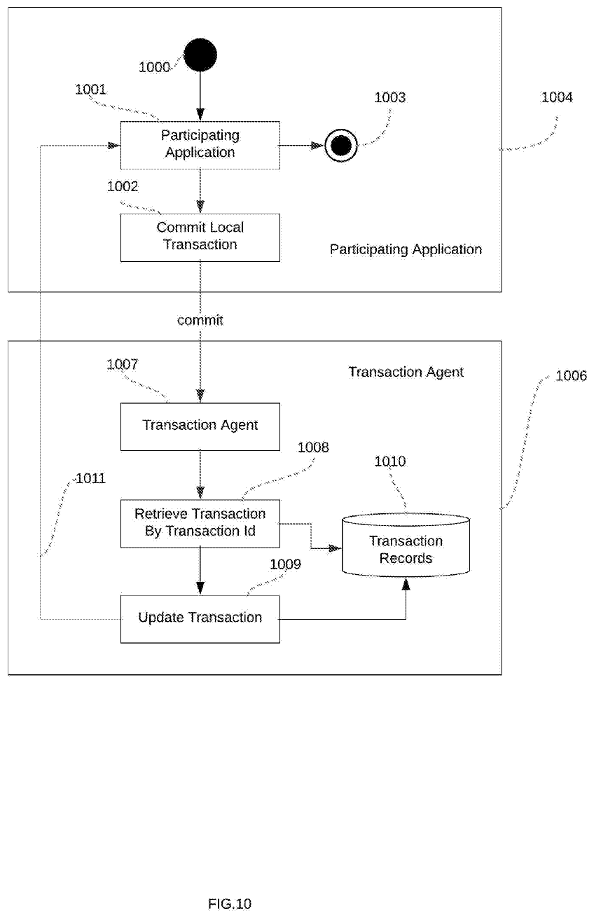

FIG. 10 depicts the commit processing of a policy-based distributed transactional system. Block 1004 is the processing flow of a participating application, and Block 1006 is the processing flow of a transaction agent. When a global transaction is ready to commit based on the policy, a participating application 1001 commits local transaction or resource(s) 1002, updates the state of the application in memory, and executes the transaction agent 1007 to update the transaction record. The transaction agent 1007 executes Block 1008 to retrieve the current transaction record associated with this application by using the transaction Id from the transaction records database 1010. Block 1009 evaluates the state of the transaction based on the policy in FIG. 5 using the new state of the application, updates the transaction record in memory, and persists it to the transaction records database 1010. Block 1009 moves the processing back to the participating application and the processing finishes.

FIG. 11 depicts the rollback processing of a policy-based distributed transactional system. Block 1104 is the processing flow of a participating application, and Block 1105 is the processing flow of a transaction agent. When a participating application fails or a transaction manager requests the participating application to rollback based on the policy, the participating application 1101 rolls back local transaction or local resource(s) 1102 and executes the transaction agent 1106. The transaction agent 1106 retrieves the current transaction record associated this application by using the transaction Id 1107 from the transaction records database 1108. Block 1109 evaluates the state of the transaction based on the policy in FIG. 5 using the new state of the application. The result state is either ACTIVE/FAILED or ROLLEDBACK 117. Block 1110 updates the transaction record in memory and persists it to the transaction records database 1108. Block 1110 moves the processing back to the participating application Block 1101. The processing 1103 finishes.

FIG. 12 depicts the failure recovery processing of a policy-based distributed transactional system. The distributed system may crash in any ways, any participating application may crash during processing, e.g., fails to prepare a commit, fails to commit, a server system may crash, a message manager may crash, a network connection involved in distributed processing may drop, any unhandled software error may occur. Any failure could result in inconsistency of a distributed system. Any participating application that restarts must execute failure recovery process to turn the system back to the original consistent state. FIG. 11 consists of two parts of failure recovery processing flow. 1213 is the processing flow of a participating application and 1211 is the processing flow of a transaction agent. A participating application 1201 restarts after a failure. The application 1201 executes failure recovery processing through a transaction agent 1205. Block 1206 retrieves the latest active transaction record using the policy Id and application Id from the transaction records database 1207. This is the active transaction that is not finished when the system fails. As defined, the transaction record is thread-safe. Only one of recovery processes updates the transaction record at a time. Block 1208 evaluates the state of the transaction record based on the policy defined in FIG. 5. The legal states are COMMITTED, ACTIVE/PREPARED, ACTIVE/FAILED, and ROLLEDBACK. If the state of the transaction record that is retrieved from the database is different from the state that is evaluated by Block 1208, it indicates there is inconsistency of the system. Block 1209 updates the transaction record with the new state and persists it to the transaction records database 1207. Block 1209 returns the processing back to the participating application 1201. Block 1201 utilizes the following algorithm to determine how to recover the participating application and the system of failure:

IF The state of the transaction is ACTIVE
The state of each participating application shall be either ACTIVE or INACTIVE
Block 1201 goes to Block 1202 to continue processing

ELSE IF The state of the transaction is COMMITTED or ROLLEDBACK

The state of the application shall be COMMITTED or ROLLEDBACK
Block 1201 goes to Block 1202 to continue processing

ELSE IF The state of the transaction is ACTIVE/PREPARED

IF The state of the application is PREPARED
Block 1201 goes to Block 1204 to execute commit
ELSE IF The state of the application is ACTIVE or INACTIVE
Block 1201 goes to Block 1202 to continue processing

ELSE IF The state of the transaction is ACTIVE/FAILED
IF The state of the application is FAILED or PREPARED
   Block 1201 goes to Block 1023 to execute rollback
ELSE IF The state of the application is ROLLEDBACK
   Block 1201 goes to Block 1202 to continue processing

ELSE IF The state of the application is INACTIVE or ACTIVE
Block 1201 goes to Block 1202 to continue processing

Each participating application executes failure recovery process to retain the global consistency of the distributed system.

Although the foregoing descriptions of the preferred embodiments of the present inventions have shown, described, or illustrated the fundamental novel features or principles of the inventions, it is understood that various omissions, substitutions, and changes in the form of the detail of the methods, elements or apparatuses as illustrated, as well as the uses thereof, may be made by those skilled in the art without departing from the spirit of the present inventions. Hence, the scope of the present inventions should not be limited to the foregoing descriptions. Rather, the principles of the inventions may be applied to a wide range of methods, systems, and apparatuses, to achieve the advantages described herein and to achieve other advantages or to satisfy other objectives as well.

1. A system of distributed processing of transactions comprising
one or more configurable policy records each of which stores the definition of a transaction and specifies which two or more participating applications are included in the processing of the transaction and one or more rules that specify conditions each participating application need to follow when processing the transaction to ensure the integrity of the transaction, wherein a participating application is implemented by a computer program and is either a producer which produces messages over time or a consumer which receives messages over time from one or more producers to whom it subscribes, and a participating application updates the state of the processing of a transaction and/or a configurable policy record of a transaction independent of the other participating applications;
a message manager that receives and stores one or more messages over time from one or more producers and distributes the messages to one or more subscribing consumers of the messages; and
a transaction state record that records the states of processing of a transaction by the participating applications,
wherein each participating application, acting independently from other participating applications, starts or joins a transaction based on a policy record of the transaction, processes one or more messages from one or more producers to whom it subscribes, updates its state of processing in the transaction state record, and checks the policy record to determine its next action.

2. The system of claim 1 wherein a rule of a transaction in the policy record specifies that a global transaction is ready to commit if all participating applications are prepared to commit by a transaction boundary time defined in the policy record and requires each participating application to commit its action upon knowing from the transaction state record that a global transaction is ready to commit; and wherein when each participating application is prepared to commit its action, it updates its state in the transaction state record to indicate that it is prepared to commit, and upon knowing from the transaction state record that all specified participating applications participating in the transaction have updated their transaction state to indicate that they are prepared to commit, each participating application commits its action and updates its state in the transaction state record by the transaction boundary time.

3. The system of claim 1 wherein a rule of a transaction in the policy record specifies that a global transaction fails if one or more participating application fails to process or fail to complete by a transaction boundary time defined in the policy record and requires each participating application to rollback its action when a global transaction fails; and wherein each participating application completes its processing but rolls back its action by reversing to its previous state upon knowing from the transaction state record that one or more participating applications in the transaction fail to process or fail to complete by the transaction boundary time.

4. The system in claim 1 wherein a rule of a transaction in the policy record specifies that upon knowing from the transaction state record that one or more other participating applications in the transaction have failed, a participating application stops processing the transaction and rolls back its action.

5. The system of claim 1 further comprising a transaction state notifier that notifies each participating application in a transaction when the transaction state record is updated.

6. The system of claim 1 wherein each participating application performs a failure recovery process based on a policy in the policy record of the transaction.

7. The system of claim 1 further comprising a policy manager which accepts input from a user interface or an API, generates or edits a policy record of a transaction, including the definition of a transaction, the rules and the transaction boundary time.

8. The system of claim 1 further comprising a policy manager wherein one or more participating applications access the policy record of a transaction and edit some or all parts of the policy record through the policy manager, including definition of a transaction, the rules and the transaction boundary time.

9. A method of distributed processing of transactions comprising
using one or more configurable policy records to store the definition of a transaction and specify which two or more participating applications are included in the processing of the transaction and one or more rules that specify conditions each participating application need to follow when processing the transaction to ensure the integrity of the transaction, wherein a participating application is implemented by a computer program and is either a producer which produces messages over time or a consumer which receives messages over time from one or more producers to whom it subscribes;
accepting from a participating application update of the state of the processing of a transaction and/or update of a configurable policy record of a transaction independent of the other participating applications;
using a message manager to receive and stores one or more messages over time from one or more producers and distributes the messages to one or more subscribing consumers of the messages; and
recording the states of processing of a transaction by the participating applications in a transaction state record,
wherein each participating application, acting asynchronously and independently from other participating applications, starts or joins a transaction based on a policy, updates its state of processing in the transaction state record, and checks the policy record to determine its next action.

10. The method of claim 9 wherein a rule of a transaction in the policy record specifies a global transaction is ready to commit if all participating applications are prepared to commit by a transaction boundary time defined in the policy record and requires each participating application to commit its action upon knowing from the transaction state record that a global transaction is ready to commit; and wherein when each participating application is prepared to commit its action, it updates its state in the transaction state record to indicate that it is prepared to commit, and upon knowing from the transaction state record that all specified participating applications participating in the transaction have updated their transaction state record to indicate that they are prepared to commit, each participating application commits its action and updates its state in the transaction state record by the transaction boundary time.

11. The method of claim 9 wherein a rule of a transaction in the policy record specifies that a global transaction fails if one or more participating application fails to process or fail to complete by a transaction boundary time defined in the policy record and requires each participating application to rollback its action when a global transaction fails; and wherein each participating application completes its processing but rolls back its action by reversing to its previous state upon knowing from the transaction state record that one or more participating applications in the transaction fail to process or fail to complete by the transaction boundary time.

12. The method of claim 9 wherein a rule of a transaction in the policy record specifies that upon knowing from the transaction state record that one or more other participating applications in the transaction have failed, a participating application stops processing the transaction and rolls back its action.

13. The method of claim 9 further comprising using a transaction state notifier to notify each participating application in a transaction when the transaction state record is updated.

14. The method of claim 9 further comprising each participating application performing a failure recovery process based on a policy in the policy record of the transaction.

15. The method of claim 9 further comprising accepting an input from a user interface or an API and generating or editing the transaction policy record of a transaction, including the definition of a transaction, the rules and the transaction boundary time.

16. The method of claim 9 further comprising one or more participating applications accessing the policy record of a transaction and edit some or all parts of the policy record through a policy manager, including definition of a transaction, the rules and the transaction boundary time.
